(19) United States
(12) Patent Application Publication
(10) Pub. No.: US 2026/0104738 A1
(43) Pub. Date: Apr. 16, 2026

(54) FOLDABLE DISPLAY DEVICE

(71) Applicant: Samsung Display Co., Ltd., Yongin-Si (KR)

(72) Inventors: IN SOO PARK, Yongin-si (KR); Sang Hyo PARK, Yongin-si (KR); Sung Sang AHN, Yongin-si (KR)

(21) Appl. No.: 19/276,028

(22) Filed: Jul. 22, 2025

(30) Foreign Application Priority Data
Oct. 16, 2024 (KR) 10-2024-0141317

(51) Int. Cl. G06F 1/16

(52) U.S. Cl. CPC G06F 1/1652; G06F 1/1681

(57) ABSTRACT

A foldable display device is disclosed that includes a display module including a display panel having a first surface and a second surface, a protection layer on the first surface, and a plate on the second surface. A first supporting member includes a third surface facing the plate, a fourth surface opposite the third surface, and a protrusion protruding from the fourth surface. A second supporting member includes a first support facing the first supporting member in a first direction and having a first groove that accommodates the protrusion, and a second support extending from the first support and facing a terminal portion of the protection layer. The terminal portion of the protection layer is affixed to the second supporting member. When the foldable display device is folded from an open position, the protrusion moves relative to the first groove in a second direction crossing the first direction.

### CROSS-REFERENCE TO RELATED APPLICATION

This application claims priority to and the benefit of Korean Patent Application No. 10-2024-0141317 filed at the Korean Intellectual Property Office on October 16, 2024, the entire contents of which are incorporated herein by reference.

### BACKGROUND

### 1. Field

The present disclosure relates to a foldable display device.

### 2. Description of the Related Art

A display device displays images on a screen, and includes a liquid crystal display (LCD) and an organic light emitting diode (OLED) display. The display device is used for various electronic devices such as a portable phone, a navigation system, a digital camera, an electronic book, a portable game device, or various terminals.

The display device, for example an organic light emitting device may be folded or bent using a flexible substrate. A foldable display device may have a foldable structure, have a wide screen, and be highly portable.

When the foldable display device is folded or unfolded, each layer included in the display module may slide over the other.

### SUMMARY

The present disclosure attempts to provide a foldable display device that minimizes bezels.

An embodiment of a foldable display includes: a display module including a display panel having a first surface and a second surface on opposite sides, a protection layer disposed on the first surface, and a plate disposed on the second surface, the display panel, the protection layer, and the plate are stacked in a first direction; a first supporting member including a third surface facing the plate and a fourth surface opposite to the third surface, and further including a protrusion protruding from the fourth surface; and a second supporting member including a first support facing the first supporting member in the first direction and having a first groove that accommodates the protrusion, and a second support extending in the first direction from the first support and facing a terminal portion of the protection layer, wherein the terminal portion of the protection layer is affixed to the second supporting member and, when the foldable display device is folded from an open position, the protrusion moves relative to the first groove in a second direction crossing the first direction.

The first groove may be an opening penetrating the first support, and the foldable display device may further include a first connecting member having a length of the second direction that is greater than a length of the first groove in the second direction and contacting the protrusion penetrating the first groove in the first direction, and a second connecting member penetrating the first connecting member and coupled to the protrusion.

An embodiment of a foldable display device includes: a display module including a display panel having a first surface and a second surface on opposite sides, a protection layer disposed on the first surface, and a plate disposed on the second surface, the display panel, the protection layer, and the plate are stacked in a first direction; a third supporting member including a third support facing the plate in the first direction, and a fourth support extending in the first direction from the third support and facing a terminal portion of the protection layer, the third support including a second groove; and a sliding member including a junction facing the plate in the first direction and extending in the first direction, and a hook facing the junction in the first direction and having a length in a second direction crossing the first direction that is greater than a length of the junction in the second direction, wherein the terminal portion of the protection layer is affixed to the fourth support and, when the foldable display device is folded from an open position, the sliding member moves relative to the second groove in the second direction.

A portion of the third support may be arranged between a terminal portion of the hook in the second direction and the plate, and may restrict movement of the display module in the first direction.

The terminal portion of the protection layer may be affixed to the fourth support in the first direction by a first adhesive member.

The sliding member and the plate may be integrally formed.

The foldable display device may further include a second adhesive member disposed between the junction and the plate.

The terminal portion of the protection layer may directly contact the fourth support in the second direction.

The display module may further include a transparent layer disposed between the protection layer and the display panel, and the terminal portion of the protection layer may protrude further in the second direction than the terminal portion of the transparent layer.

The second groove may include a first groove portion disposed near the plate and a second groove portion distant from the plate, a length of the first groove portion in the second direction may be less than a length of the second groove portion in the second direction, the junction may be accommodated in the first groove portion, a length of the first groove portion in the second direction may be greater than a length of the junction in the second direction, and the hook may be accommodated in the second groove portion, and a length of the second groove portion in the second direction may be greater than a length of the hook in the second direction.

An entire region of a surface of the protection layer may be exposed from the third supporting member.

An embodiment of a foldable display device includes: a display module including a display panel having a first surface and a second surface on opposite sides, a protection layer disposed on the first surface, and a plate disposed on the second surface, the display panel, the protection layer, and the plate are stacked in a first direction; a fourth supporting member facing the plate in the first direction and extending in a second direction crossing the first direction; and a fifth supporting member having a third groove facing the fourth supporting member in the second direction, extending in the first direction, and facing a terminal portion of the protection layer, wherein the terminal portion of the protection layer is affixed to the fifth supporting member and, when the foldable display device is folded from an open position, the fourth supporting member moves relative to the third groove in the second direction.

The fourth supporting member may be in surface contact with the fifth supporting member in the first direction in the third groove.

The terminal portion of the protection layer may be affixed to the fifth supporting member in the first direction by the first adhesive member.

The third groove may be formed on a surface disposed near the fourth supporting member which is adjacent to the fifth supporting member.

The foldable display device may further include an adhesive layer disposed between the fourth supporting member and the display module.

The terminal portion of the protection layer may directly contact the fifth supporting member in the second direction.

The display module may further include a transparent layer disposed between the protection layer and the display panel, and the terminal portion of the protection layer may protrude further in the second direction than the terminal portion of the transparent layer.

A terminal portion of the fourth supporting member in the second direction may protrude further in the second direction than a terminal portion of the plate in the second direction.

An entire region of a surface of the protection layer may be exposed from the fifth supporting member.

According to the embodiments, when the foldable display device is folded or unfolded, the upper portion of the display module may be affixed and the lower portion of the display module may be configured to slide, thereby minimizing the bezel of the foldable display device.

### BRIEF DESCRIPTION OF THE DRAWINGS

FIG. 1 shows a perspective view of a foldable display device according to an embodiment.

FIG. 2 shows a cross-sectional view of a portion of a foldable display device relative to a line II-II’ of FIG. 1 according to an embodiment.

FIG. 3 shows an enlarged region III of FIG. 2.

FIG. 4 shows a bottom view of FIG. 3.

FIG. 5 shows a display module and an adhesive layer.

FIG. 6 shows a cross-sectional view of a display module folded by an in-folding method.

FIG. 7 shows a structure in which a sliding member is integrally formed with a plate and it slides relative to a third supporting member.

FIG. 8 shows a structure in which a sliding member is independently formed from a plate and it slides relative to a third supporting member.

FIG. 9 shows a structure in which a fourth supporting member slides in a third groove formed by two surfaces relative to a fifth supporting member.

FIG. 10 shows a structure in which a fourth supporting member slides in a third groove formed by three surfaces relative to a fifth supporting member.

FIG. 11 is a block diagram of the foldable display device according to an embodiment.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

The drawings and description are to be regarded as illustrative in nature and not restrictive, and like reference numerals designate like elements throughout the specification.

The size and thickness of each configuration shown in the drawings are arbitrarily shown for better understanding and ease of description, but the present disclosure is not limited thereto. In the drawings, the thicknesses of layers, films, panels, regions, etc., are enlarged for clarity. The thicknesses of some layers and areas are exaggerated for convenience of explanation.

It should be understood that when an element such as a layer, film, region, or substrate is referred to as being “on” another element, it can be directly on the other element or intervening elements may also be present. In contrast, when an element is referred to as being “directly on” another element, there are no intervening elements present. The word “on” or “above” means positioned on or below the object portion, and does not necessarily mean positioned “on” or “above” the upper side of the object portion based on a gravitational direction.

Unless explicitly stated to the contrary, the words “comprise” and “include” as well as variations such as “comprises” and “comprising” should be understood to imply the inclusion of stated elements but not the exclusion of any other elements.

The phrase “on a plane” means viewing the object portion from the top, and the phrase “in a cross-section” means viewing a cross-section of which the object portion is vertically cut from the side.

Embodiments of the present disclosure will now be described with reference to accompanying drawings.

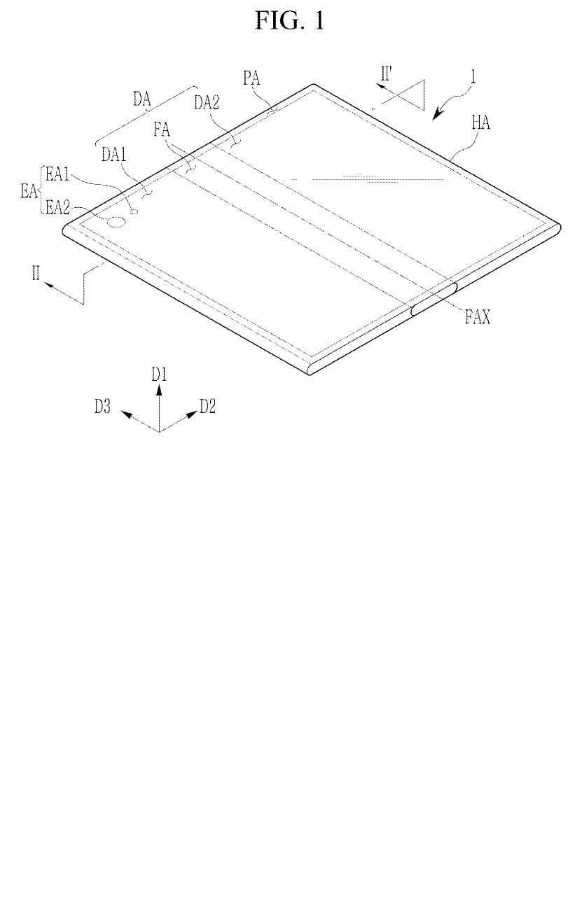

FIG. 1 shows a perspective view of a foldable display device according to an embodiment.

A display device displays videos or still images, and may be used as a display screen of portable electronic devices such as mobile phones, smartphones, tablet personal computers, mobile communication terminals, or electronic notebooks, and various products such as televisions, laptops, monitors, billboards, or Internet of things (IOT).

The display device may include a display area and a non-display area. The display area may display videos or still images. The non-display area may display no videos or still images. The non-display area may surround the display area.

A foldable display device 1 may display images on a display surface in a first direction D1. The display surface on which images are displayed may correspond to a front surface of the foldable display device 1. The images may include videos and still images. The foldable display device may be an example of an electronic device.

The foldable display device 1 may be folded by an in-folding method so that the display area DA may face inward relative to a folding axis FAX. When the foldable display device 1 is folded by the in-folding method, the display area DA may be invisible from an outside.

The foldable display device 1 may include a display area DA, a component area EA, and a non-display area PA.

The display area DA may be divided into a first display area DA1, a second display area DA2, and a folding area FA. The first display area DA1 and the second display area DA2 may be disposed on the left and the right of (or relative to) the folding axis FAX, and the folding area FA may be disposed between the first display area DA1 and the second display area DA2. When folded outward relative to the folding axis FAX, the first display area DA1 and the second display area DA2 may be disposed on both sides in the first direction D1 and may display images in both directions. When folded inward relative to the folding axis FAX, the first display area DA1 and the second display area DA2 may not be visible from the outside.

The component area EA of the foldable display device 1 may include a first component area EA1 and a second component area EA2. The first component area EA1 and the second component area EA2 may be at least partly surrounded by the display area DA. The first component area EA1 and the second component area EA2 are shown to be spaced apart from each other, and without being limited thereto, they may be at least partly connected to each other. Optical elements using infrared rays, visible rays, or sound may be arranged on lower portions of the first component area EA1 and the second component area EA2.

The non-display area PA may not display images, and driving circuits or driving wires for displaying the display area DA may be arranged in the non-display area PA.

The display area DA may be surrounded by a housing HA. The display area DA may be exposed from the housing HA. The housing HA may form an exterior of the foldable display device 1, and may protect the display module.

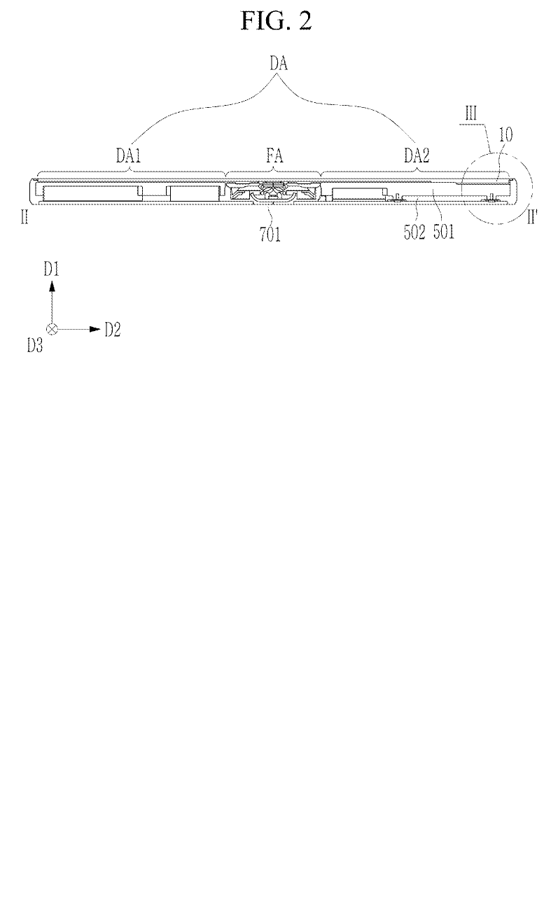

FIG. 2 shows a cross-sectional view of a portion of the foldable display device relative to a line II-II’ of FIG. 1 according to an embodiment.

FIG. 2 shows a configuration of the foldable display device, excluding the housing (see FIG. 1), showing a display module 10, a first supporting member 501, a second supporting member 502, and a hinge 701. FIG. 2 shows a first display area DA1, a second display area DA2, and a folding area FA. FIG. 2 shows the unfolded display module 10.

The hinge 701 may be configured so that the display module 10 may be folded or unfolded. The folding area FA may be formed by the hinge 701. The folding area FA may be arranged between the first display area DA1 and the second display area DA2. The hinge 701 may be combined with the display module 10, the first supporting member 501, and the second supporting member 502. The first supporting member 501 and the second supporting member 502 may move together according to movement of the hinge 701. The structure of the hinge 701 may not be limited. For example, the hinge 701 may include a gear arm that is affixed with a pin and is rotated.

The display module 10 may be surrounded by the first supporting member 501 and the second supporting member 502. The display module 10 may be supported by the first supporting member 501 and the second supporting member 502.

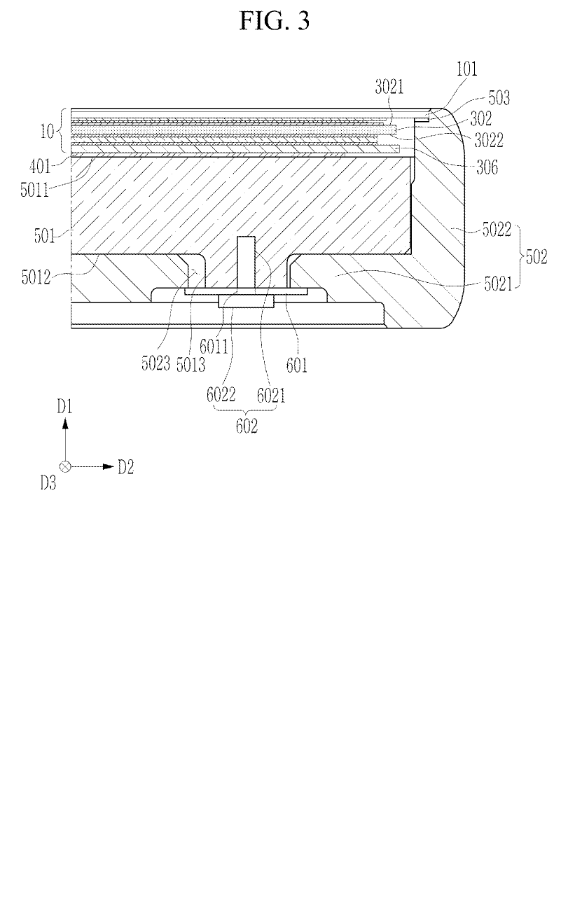

FIG. 3 shows an enlarged region III of FIG. 2.

FIG. 3 shows a display module 10, a first supporting member 501, a second supporting member 502, a first connecting member 601, and a second connecting member 602.

The display module 10 may include a display panel 302, a protection layer 101, and a plate 306.

The display panel 302, the protection layer 101, and the plate 306 may be stacked in the first direction D1. For example, the plate 306, the display panel 302, and the protection layer 101 may be sequentially stacked in the first direction D1. The protection layer 101 may be disposed between the display panel 302 and the plate 306. The display module 10 may include additional layers other than the display panel 302, the protection layer 101, and the plate 306 as needed.

The display panel 302 may include a first surface 3021 and a second surface 3022 on opposite sides. The first surface 3021 may be the surface disposed on the side for displaying images from among both surfaces of the display panel 302. The second surface 3022 may be opposite to the first surface, and may be disposed on the non-image displaying side of the display panel 302. The first surface 3021 and the second surface 3022 may extend in a second direction D2 and a third direction D3. The third direction D3 may traverse the first direction D1 and the second direction D2, respectively.

The protection layer 101 may be disposed on the first surface 3021 of the display panel 302. The protection layer 101 may be disposed on an upper portion of the display panel 302. The protection layer 101 may be an uppermost layer of the display module 10. The protection layer 101 may directly contact the display panel 302. Another layer may be disposed between the display panel 302 and the protection layer 101.

The plate 306 may be disposed on the second surface 3022 of the display panel 302. The plate 306 may be disposed on a lower portion of the display panel 302. The plate 306 may be a lowermost layer of the display module 10. The plate 306 may directly contact the display panel 302. Another layer may be disposed between the display panel 302 and the plate 306.

An adhesive layer 401 may be disposed on a lower portion of the display module 10. The adhesive layer 401 may be disposed between the display module 10 and a first supporting member 501. The adhesive layer 401 may bond the display module 10 and the first supporting member 501.

The first supporting member 501 may be disposed on the lower portion of the display module 10. The first supporting member 501 may be disposed on the lower portion of the plate 306. The first supporting member 501 and the display module 10 may be arranged in the first direction D1. The first supporting member 501 and the plate 306 may be arranged in the first direction D1. The first supporting member 501 may be bonded to the display module 10 by the adhesive layer 401. The first supporting member 501 may be bonded to the plate 306 by the adhesive layer 401. The first supporting member 501 may support the display module 10 on the lower portion of the display module 10. The first supporting member 501 may extend in the second direction D2 crossing the first direction D1. The first supporting member 501 may include a third surface 5011 and a fourth surface 5012. The third surface 5011 may face the plate 306. The fourth surface 5012 may be opposite to the third surface 5011. The third surface 5011 may be disposed closer to the plate 306 than the fourth surface 5012 is to the plate 306. The third surface 5011 may be disposed near the plate 306. The fourth surface 5012 may face the third surface 5011. The first supporting member 501 may include a protrusion 5013 protruding in the first direction D1 from the fourth surface 5012. The protrusion 5013 may be accommodated in a first groove 5023 of the second supporting member 502.

The second supporting member 502 may include a first support 5021 and a second support 5022. The first support 5021 may extend in the second direction D2. The first support 5021 may face the first supporting member 501 in the first direction D1. The first support 5021 may contact the first supporting member 501 in the first direction D1. The first support 5021 may contact the fourth surface 5012. The first support 5021 may have the first groove 5023 accommodating the protrusion 5013. The second support 5022 may extend in the first direction D1 from a terminal portion of the first support 5021 in the second direction D2. The second support 5022 and the display module 10 may be arranged in the second direction D2. The second support 5022 may face a terminal portion of the protection layer 101 in the second direction D2. The second support 5022 may contact the first supporting member 501 in the second direction D2. The second supporting member 502 may be formed by integrally connecting the first support 5021 and the second support 5022. The second supporting member 502 may surround the first supporting member 501. The first supporting member 501 may be accommodated in a recess portion formed by the second supporting member 502. The second supporting member 502 may support the first supporting member 501 on a side of the first direction D1 and a side of the second direction D2.

The terminal portion of the protection layer 101 in the second direction D2 may be affixed to the second supporting member 502. The protection layer 101 and the second supporting member 502 may be affixed in the first direction D1. A first adhesive member 503 may be disposed between the protection layer 101 and the second supporting member 502. The protection layer 101, the first adhesive member 503, and the second support 5022 may be sequentially arranged in the first direction D1.

The protection layer 101 and the second supporting member 502 are fixed, so when the foldable display device is folded or unfolded, relative positions of the protection layer 101 and the second supporting member 502 may not be changed. When the foldable display device is folded or unfolded, each layer of the display module 10 may move relative to each other in the second direction D2. When the foldable display device is folded or unfolded, each layer of the display module 10 may slide in the second direction D2. This is because each layer of the display module 10 moves with a different curvature radius in the folding area FA when the foldable display device is folded or unfolded (see FIG. 2). The first supporting member 501 is connected to the display module 10 through the adhesive layer 401 so it may move relative to the second direction D2 when the foldable display device is folded or unfolded.

The first groove 5023 may be formed in the first support 5021. The first groove 5023 may have a circular shape when viewed from the first direction D1. The first groove 5023 may be an opening penetrating the first support 5021. The first groove 5023 may be surrounded by the first support 5021. The length of the first groove 5023 in the first direction D1 may correspond to the length of the protrusion 5013 in the first direction D1. The length of the first groove 5023 in the first direction D1 may be equal to or greater than the length of the protrusion 5013 in the first direction D1. Multiple first grooves 5023 may be provided in the first support 5021. The first groove 5023 may penetrate the first support 5021 in the first direction D1. The length of the first groove 5023 in the second direction D2 may be greater than the length of the protrusion 5013 in the second direction D2. The protrusion 5013 may move in the second direction D2 relative to the second supporting member 502 in the first groove 5023.

The first connecting member 601 and the first groove 5023 may be arranged in the first direction D1. The first connecting member 601 may face the first groove 5023 in the first direction D1. The first connecting member 601 may contact an edge of the first groove 5023. The first connecting member 601 may have a ring shape when viewed from the first direction D1. The first connecting member 601 may form a penetrating portion 6011 in a center of a plane formed by the second direction D2 and the third direction D3. The penetrating portion 6011 may have a circular shape when viewed from the first direction D1. The length of the first connecting member 601 in the second direction D2 may be greater than the length of the first groove 5023 in the second direction D2. The first connecting member 601 may contact the protrusion 5013 penetrating the first groove 5023 in the first direction D1. Both terminal portions of the first connecting member 601 in the second direction D2 may contact the first support 5021 in the first direction D1. For example, the first connecting member 601 may be a washer.

The second connecting member 602 may penetrate the first connecting member 601 and may be coupled with the protrusion 5013. The second connecting member 602 may penetrate the penetrating portion 6011 of the first connecting member 601. The second connecting member 602 may include a body 6021 and a head 6022. The body 6021 may penetrate the penetrating portion 6011 of the first connecting member 601 and may be inserted into the first supporting member 501. The body 6021 may be inserted into the penetrating portion 6011 at the center of the first connecting member 601. The body 6021 may have a cylindrical shape in the first direction D1. The body 6021 and the head 6022 may be integrally formed. The head 6022 and the first connecting member 601 may be arranged in the first direction D1. The length of the head 6022 in the second direction D2 may be greater than the length of the penetrating portion 6011 in the second direction. The length of the head 6022 in the second direction D2 may be greater than the length of the body 6021 in the second direction D2. For example, the second connecting member 602 may be a screw.

Referring to FIG. 2, when the foldable display device is folded by the in-folding method, the display module 10 and the first supporting member 501 may be rotated counterclockwise relative to the hinge 701 as an axis and the first display area DA1 as a fixed plane. The display module 10 and the first supporting member 501 may be rotated when a force transmitted from the hinge works in the first direction D1 and the direction opposite to the second direction D2. The force transmitted from the hinge and going in the first direction D1 may work so that the first supporting member 501 may move in the first direction D1. However, the first connecting member 601 and the second connecting member 602 may prevent the first supporting member 501 from leaving the second supporting member 502 in the first direction D1. Specifically, the second connecting member 602 penetrates the first connecting member 601 and is connected to the first supporting member 501 so the first connecting member 601, the second connecting member 602, and the first supporting member 501 may be connected as one. As both terminal portions of the first connecting member 601 in the second direction D2 contact the second supporting member 502 in the first direction D1, the first supporting member 501 may not be spaced apart from the second supporting member 502 in the first direction D1 when receiving force in the first direction D1. When the first supporting member 501 receives force in the first direction D1, both terminal portions of the first connecting member 601 in the second direction D2 receive force from the second supporting member 502 in the opposite direction to the first direction D1 so the first supporting member 501 may not move in the first direction D1.

As the first supporting member 501 and the second supporting member 502 are coupled by the first connecting member 601 and the second connecting member 602, the first supporting member 501 may not move in the first direction D1. The first supporting member 501 may move in the second direction D2 relative to the second supporting member 502. When the foldable display device is folded or unfolded, the first supporting member 501 may directly contact the second supporting member 502 and may stabilize the display module 10. As the display module 10 and the first supporting member 501 do not move in the first direction D1 in relative relationship to the second supporting member 502, adherence of the protection layer 101 and the second supporting member 502 may be stably maintained. When the display module 10 and the first supporting member 501 move in the first direction D1 in relative relationship to the second supporting member 502, the protection layer 101 may receive force to be detached from the second supporting member 502.

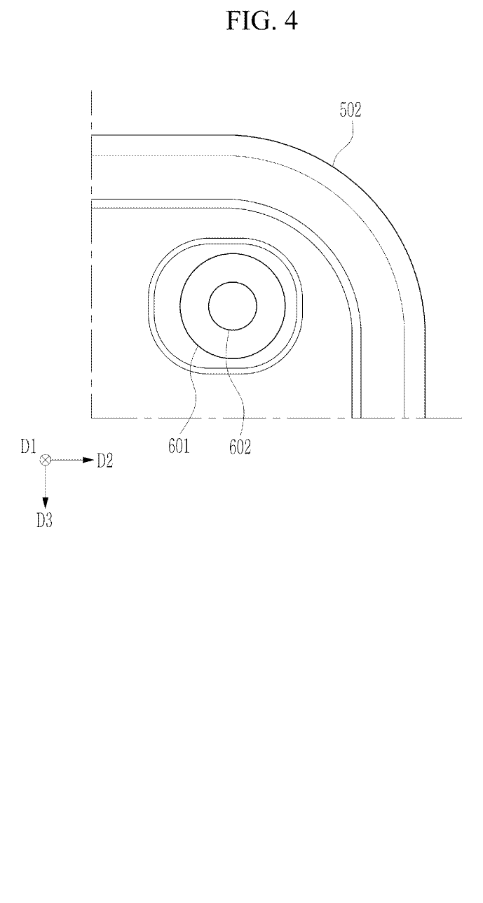

FIG. 4 shows a bottom view of FIG. 3. FIG. 4 shows a first connecting member 601 and a second connecting member 602 coupled to the second supporting member 502.

The first connecting member 601 may contact the second supporting member 502. The second connecting member 602 may penetrate the first connecting member 601 and may be coupled with the first supporting member.

When the foldable display device is folded or unfolded, the first supporting member may move relative to the second supporting member 502 in the second direction D2. When the first supporting member moves in the second direction D2 relative to the second supporting member 502, the first connecting member 601 and the second connecting member 602 may also move in the second direction D2 relative to the second supporting member 502.

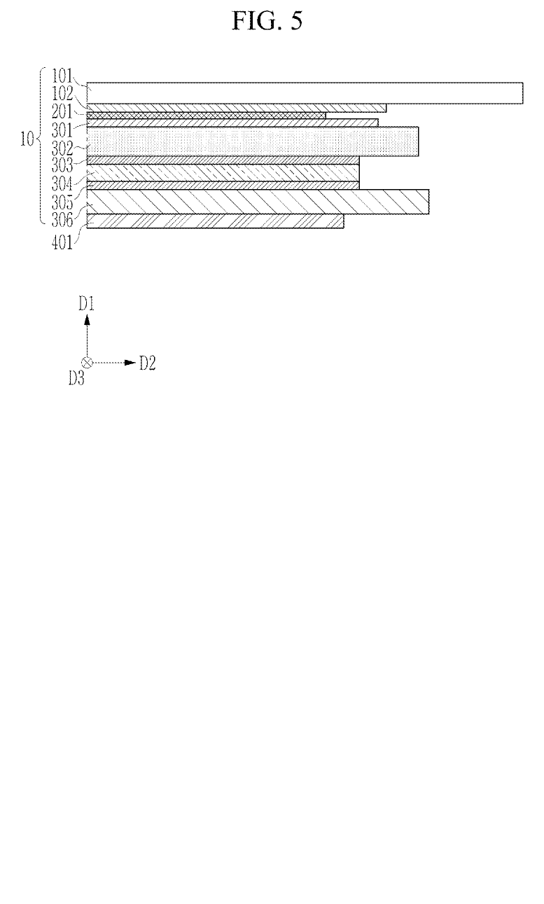

FIG. 5 shows a display module and an adhesive layer.

The display module 10 included in the foldable display device will now be described with reference to FIG. 5.

The display module 10 may include the display panel 302. Although not shown in FIG. 5, the display module 10 may include a flexible printed circuit board (FPCB) extending from a surface of a terminal portion of the display panel 302 and attached to a terminal portion of a surface of the plate 306. The FPCB is a flexible circuit board, and may be attached to a predetermined region of a rear surface of the plate 306 configuring a rear surface of the display module 10 or a rear surface of the display panel 302 from an upper surface of the display panel 302.

The display module 10 may further include a polymer member 304 arranged on a lower portion of the display panel 302, an adhesive layer 303 arranged between the display panel 302 and the polymer member 304, and an adhesive layer 305 arranged between the polymer member 304 and the plate 306. An adhesive layer 401 for attaching other parts that are different from the display module 10 may be further arranged below the display module 10. The adhesive layers 303, 305, and 401 may include at least one of an optical clear adhesive (OCA), a pressure sensitive adhesive (PSA), a heat reactive adhesive, a general adhesive, or a double-sided adhesive tape.

Dark color (e.g., black) may be applied to the polymer member 304 to allow visibility of a background when the screen is turned off. For example, the polymer member 304 may function as a cushion for absorbing external impacts of the foldable display device and preventing breakage of the display module 10.

The plate 306 may assist to reinforce rigidity of the foldable display device, may shield noise, and may disperse heat discharged from a heat generated part. For example, the plate 306 may include at least one of steel use stainless (SUS) (e.g., stainless steel (STS)), Cu, Al, or CLAD (e.g., a stacking member in which SUS and Al are alternately arranged). The plate 306 may include other alloy materials.

The display module 10 may further include a polarization layer 301 arranged on the display panel 302. The polarization layer 301 transmits light vibrating in the same direction as a polarization axis from among light discharged from the display panel 302, and absorbs or reflects light vibrating in other directions. The polarization layer 301 may include a phase difference film for changing linear polarization into circular polarization or changing circular polarization into linear polarization by assigning a phase difference of λ/4 to two polarization components that are perpendicular to each other, and a polarization film for aligning the direction of light passing through the phase difference film, dividing the light into two polarization components that are orthogonal to each other, allowing one of the two components to pass through, and absorbing or dispersing other components. In some cases, the polarization layer 301 may be omitted.

The protection layer 101 may be arranged on the display panel 302. The protection layer 101 may be a polymer layer. The protection layer 101 may include PET or polyimide. The protection layer 101 may be an uppermost layer of the display module 10.

The display module 10 may further include a transparent layer 102 disposed between the protection layer 101 and the display panel 302. An adhesive layer 201 may be arranged between the transparent layer 102 and the display panel 302. The transparent layer 102 may include ultrathin glass (UTG). The terminal portion of the protection layer 101 in the second direction D2 may protrude further in the second direction D2 than the terminal portion of the transparent layer 102 in the second direction D2. That is, the protection layer 101 may be formed larger than the transparent layer 102 to protect the transparent layer 102 and help prevent scattering of fragments of the transparent layer 102 when the transparent layer 102 is broken.

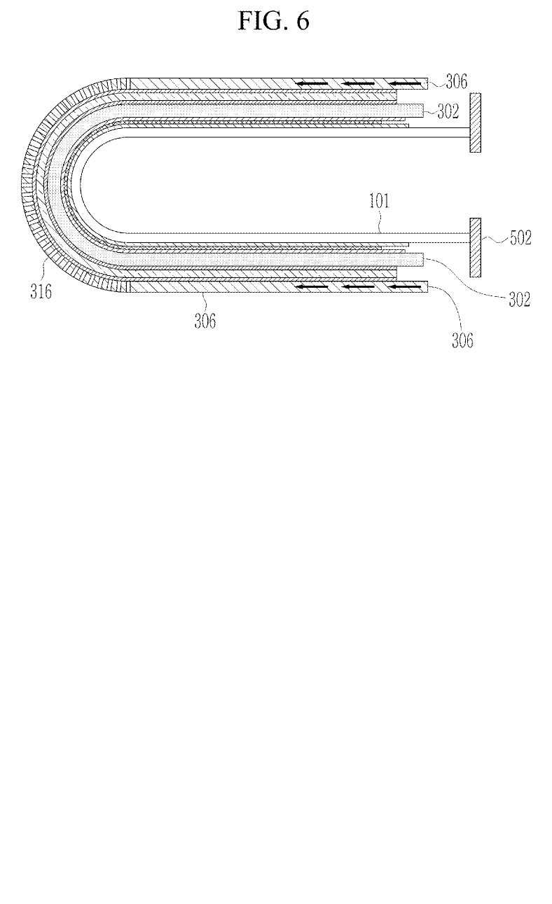

FIG. 6 shows a cross-sectional view of a display module folded by an in-folding method.

When the display module 10 is folded according to the in-folding method and the protection layer 101 is affixed to the second supporting member 502, the respective layers of the display module 10 may slide with each other. As the protection layer 101 is affixed to the second supporting member 502, the display module 10 may slide much further when the layer is further distant from the protection layer 101. For example, the plate 306 that is the most distant from the protection layer 101 may slide the most in an arrow direction of FIG. 6.

The plate 306 may include a lattice structure 316 in the folding area. The folding area may be a center of the plate 306. The lattice structure 316 may be a portion where multiple open regions are defined. The lattice structure 316 includes the open regions to increase flexibility of the folding area. The lattice structure 316 may disperse impacts and may disperse energy.

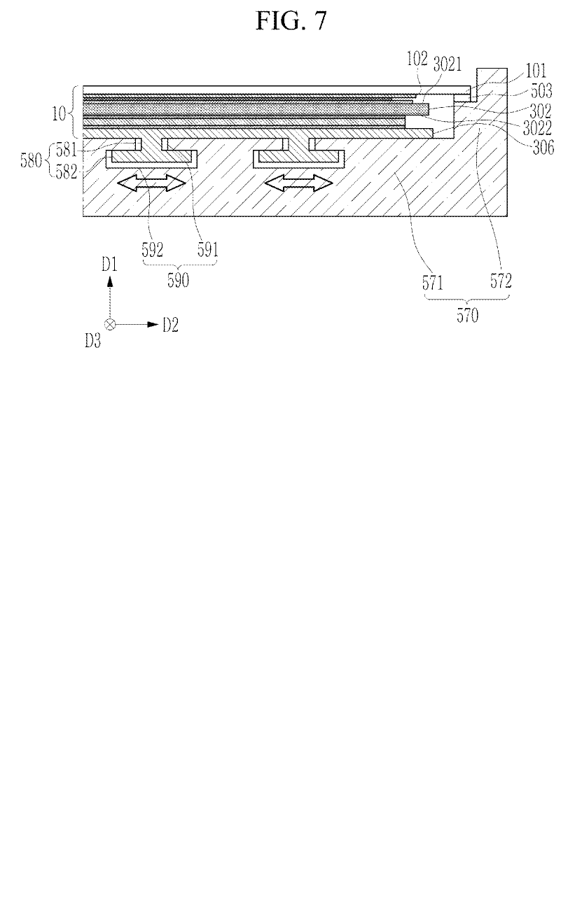

FIG. 7 shows a structure in which a sliding member is integrally formed with a plate and it slides relative to a third supporting member.

FIG. 7 shows an embodiment that is different from the embodiment shown in FIG. 3. The embodiment shown in FIG. 7 will now be described, focusing on the differences from the embodiment shown in FIG. 3.

FIG. 7 shows a third supporting member 570 and a display module 10. Regarding the foldable display device shown in FIG. 7, the plate 306 and the sliding member 580 may be integrally formed.

The third supporting member 570 may include a third support 571 and a fourth support 572. The third support 571 may face the plate 306 in the first direction D1 and may extend in the second direction D2, crossing the first direction D1. The plate 306 may move relatively in the second direction D2 in a relationship with the third support 571. The fourth support 572 may be arranged in the second direction D2 together with the display module 10 and may extend from the third support 571 in the first direction D1. The fourth support 572 may face the terminal portion of the protection layer 101 in the second direction D2. The terminal portion of the protection layer 101 of the display module 10 in the second direction D2 may be affixed to the fourth support 572. The protection layer 101 of the display module 10 may be affixed to the third supporting member 570. The third supporting member 570 may be integrally formed with the third support 571 and the fourth support 572.

The sliding member 580 and the plate 306 may be integrally formed. The sliding member 580 may include a junction 581 and a hook 582. Multiple sliding members 580 may be provided. The junction 581 may face the plate 306 in the first direction D1 and may extend in the first direction D1. The hook 582 may face the junction 581 in the first direction D1. The hook 582 may directly contact the junction 581. The length of the hook 582 in the second direction D2 may be greater than the length of the junction 581 in the second direction D2. Regarding the sliding member 580, the junction 581 and the hook 582 may be integrally formed. The terminal portion of the protection layer 101 in the second direction D2 is affixed to the fourth support 572, so when the foldable display device is folded or unfolded, the layer disposed farthest from the protection layer 101 may slide more. The sliding member 580 may move in the second direction D2 relative to the third supporting member 570 along the second groove 590 formed in the third support 571.

The second groove 590 may include a first groove portion 591 disposed near the plate 306 and a second groove portion 592 distant from the plate 306. The length of the first groove portion 591 in the second direction D2 may be less than the length of the second groove portion 592 in the second direction D2. The junction 581 may be accommodated in the first groove portion 591. The length of the first groove portion 591 in the second direction D2 may be greater than the length of the junction 581 in the second direction D2. The hook 582 may be accommodated in the second groove portion 592. The length of the second groove portion 592 in the second direction D2 may be greater than the length of the hook 582 in the second direction D2. The first groove portion 591 may be disposed between the display panel 302 and the second groove portion 592. The first groove portion 591 and the second groove portion 592 may be arranged in the first direction D1. Multiple second grooves 590 may be provided.

A portion of the third support 571 and a terminal portion of the hook 582 in the second direction D2 may contact each oter in the first direction D1. A portion of the third support 571 may be arranged between the terminal portion of the hook 582 in the second direction D2 and the plate 306. Hence, the foldable display device may restrict movement of the display module 10 in the first direction D1. When the terminal portion of the hook 582 in the second direction D2 is hooked on a portion of the third support 571 and the foldable display device is folded, the display module 10 may not leave the third supporting member 570.

The terminal portion of the protection layer 101 in the second direction D2 may be affixed to the fourth support 572 in the first direction D1 by the first adhesive member 503. The protection layer 101 is very thin in the first direction D1, so affixing the protection layer 101 and the fourth support 572 in the first direction D1 may be stronger than affixing the protection layer 101 and the fourth support 572 in the second direction D2.

An entire region of a surface of the protection layer 101 may be exposed from the third supporting member 570. The exposed surface of the protection layer 101 may display images. The protection layer 101 is affixed to the third supporting member 570, so when the foldable display device is folded or unfolded, there may be no relative movement between the protection layer 101 and the third supporting member 570. As the protection layer 101, which is the upper portion of the display module 10, does not slide in the second direction D2 but the lower portion of the display module 10 slides, the protection layer 101 may not need a bezel for covering a gap generated when it slides in the second direction. Therefore, the entire region of the surface of the protection layer 101 may be exposed, and the region of the bezel may be reduced.

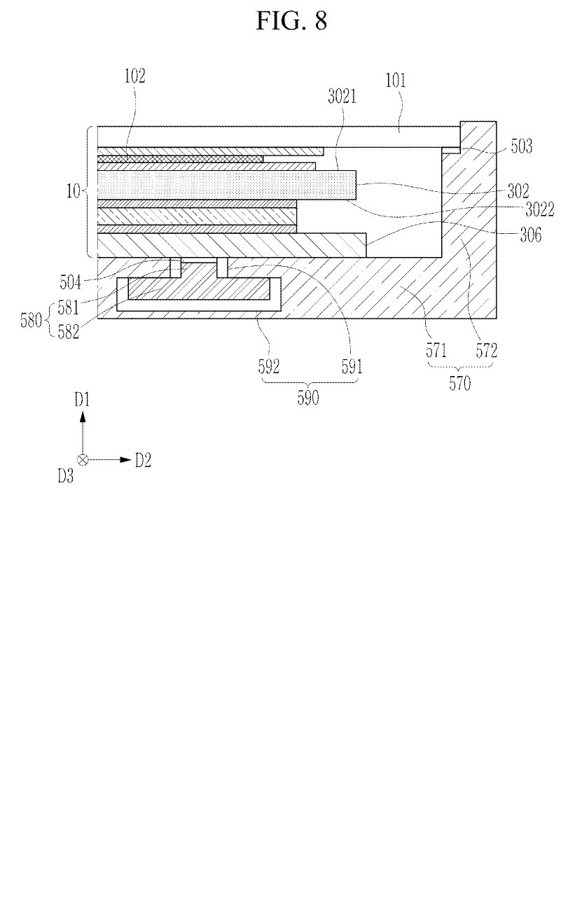

FIG. 8 shows a structure in which a sliding member is independently formed from a plate and slides relative to a third supporting member.

FIG. 8 shows an embodiment that is different from the embodiment of FIG. 3 and the embodiment of FIG. 7. The embodiment shown in FIG. 8 will now be described, focusing on the differences from the embodiment shown in FIG. 3 and the embodiment shown in FIG. 7.

FIG. 8 shows a third supporting member 570 and a display module 10. The protection layer 101 of the display module 10 may be affixed to the third supporting member 570. FIG. 8 shows a foldable display device including a sliding member 580. Unlike the embodiment of FIG. 7, according to the embodiment of FIG. 8, the sliding member 580 and the plate 306 may not be integrally formed.

The sliding member 580 may be bonded to the plate 306 by a second adhesive member 504. The second adhesive member 504 may be disposed between the junction 581 and the plate 306. The junction 581 may be affixed to the plate 306 by the second adhesive member 504 in the first direction D1. By separately manufacturing the sliding member 580 and adhering it to the plate 306, the difficulty of integrally forming the sliding member 580 and the plate 306 may be reduced.

The second adhesive member 504 does not limit a method for affixing the plate 306 and the sliding member 580. For example, the second adhesive member 504 may be an adhesive.

The terminal portion of the protection layer 101 in the second direction D2 may directly contact the fourth support 572 in the second direction D2. Hence, there may be no space between the protection layer 101 and the fourth support 572 in the second direction D2. A bezel structure for covering the space between the protection layer 101 and the fourth support 572 may not be included.

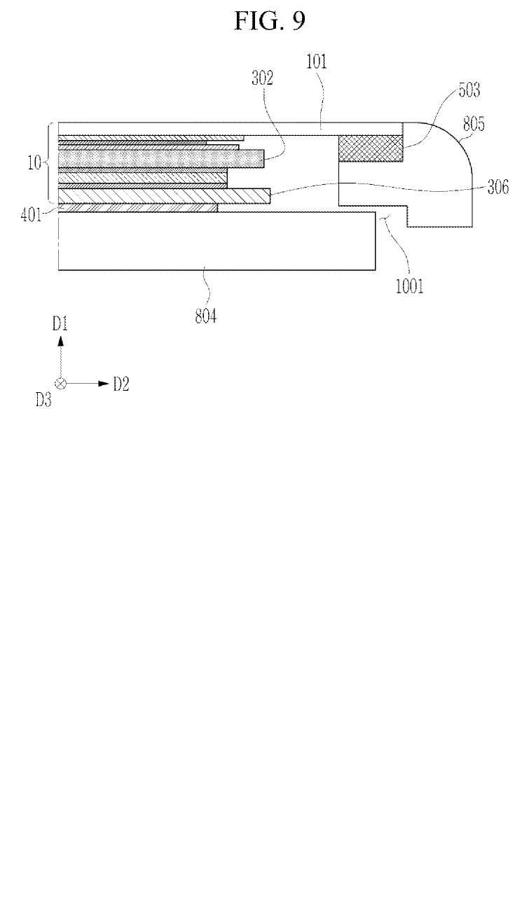

FIG. 9 shows a structure in which a fourth supporting member slides in a third groove formed by two surfaces relative to a fifth supporting member.

FIG. 9 shows an embodiment that is different from the embodiment of FIG. 3, the embodiment of FIG. 7, and the embodiment of FIG. 8. The embodiment shown in FIG. 9 will now be described, focusing on the differences from the embodiment shown in FIG. 3, the embodiment shown in FIG. 7, and the embodiment shown in FIG. 8.

FIG. 9 shows a display module 10, a fourth supporting member 804, and a fifth supporting member 805. The terminal portion of the protection layer 101 of the display module 10 in the second direction D2 may be affixed to the fifth supporting member 805. The terminal portion of the protection layer 101 in the second direction D2 may be affixed to the fifth supporting member 805 in the first direction D1 by the first adhesive member 503. The fifth supporting member 805 may include a third groove 1001.

When the foldable display device is folded or unfolded, the fourth supporting member 804 may slide in the second direction D2 relative to the fifth supporting member 805 in the third groove 1001 of the fifth supporting member 805. The fourth supporting member 804 may move in the second direction D2 relative to the fifth supporting member 805 along the third groove 1001. The fourth supporting member 804 may be in surface contact with the fifth supporting member 805 in the first direction D1 in the third groove 1001.

The third groove 1001 may be formed on a surface disposed near the fourth supporting member 804 from among a surface of the fifth supporting member 805. The third groove 1001 may be formed when two surfaces of the fifth supporting member 805 are disposed near each other. The two surfaces forming the third groove 1001 may form an L shape. Two surfaces of the fourth supporting member 804 disposed near each other may be accommodated in the third groove 1001. Three surfaces of the fourth supporting member 804 disposed near each other may be accommodated in the third groove 1001.

The fourth supporting member 804 and the fifth supporting member 805 may be connected by the display module 10. The fourth supporting member 804 may be disposed near the plate 306. The fourth supporting member 804 may face the plate 306 in the first direction D1. The plate 306 may extend in the second direction D2. The adhesive layer 401 may be disposed between the fourth supporting member 804 and the display module 10. The terminal portion of the fourth supporting member 804 in the second direction D2 may protrude further in the second direction D2 than the terminal portion of the plate 306 in the second direction D2.

The fifth supporting member 805 and the display module 10 may be arranged in the second direction D2. The fifth supporting member 805 may face the display module 10 in the second direction D2. The fifth supporting member 805 may extend in the first direction D1. The fifth supporting member 805 may face the terminal portion of the protection layer 101.

The third groove 1001 and the fourth supporting member 804 may be arranged in the second direction D2. Further, the third groove 1001 may face the fourth supporting member 804 along the second direction D2. The third groove 1001 may be formed in the fifth supporting member 805. When the foldable display device is folded or unfolded, the terminal portion of the fourth supporting member 804 in the second direction D2 may move relatively and slide in the second direction D2 relative to the fifth supporting member 805 in the third groove 1001 of the fifth supporting member 805. When the foldable display device is folded or unfolded, the fourth supporting member 804 may be in surface contact with the fifth supporting member 805 in the first direction D1 and may move in the second direction D2.

An entire region of the protection layer 101 may be exposed from the fifth supporting member 805. The exposed surface of the protection layer 101 may display images. The protection layer 101 is affixed to the fifth supporting member 805, so when the foldable display device is folded or unfolded, no relative movement may be generated between the protection layer 101 and the fifth supporting member 805. As the protection layer 101, which is the upper portion of the display module 10, does not slide in the second direction D2 and the lower portion of the display module 10 slides, the bezel for covering the gap generated when the protection layer 101 slides in the second direction may not be needed. Therefore, the entire region of the surface of the protection layer 101 may be exposed, and the region of the bezel may be reduced.

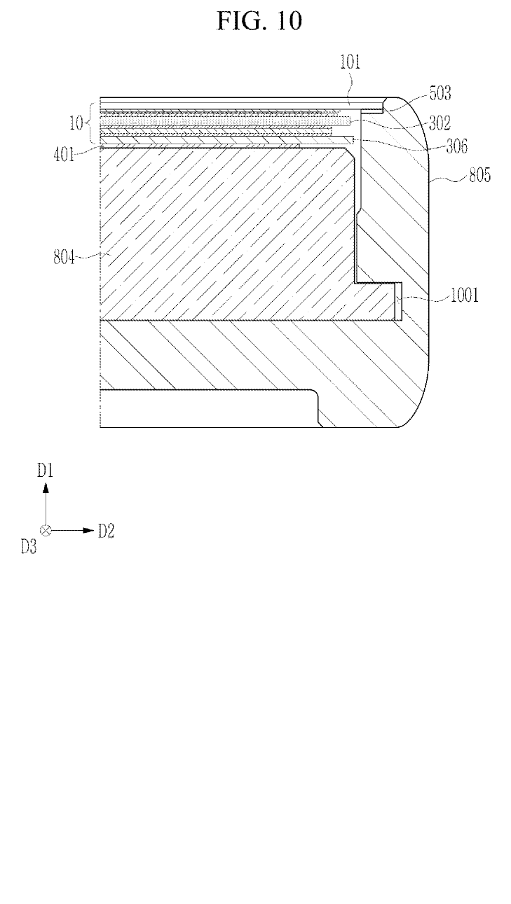

FIG. 10 shows a structure in which a fourth supporting member slides in a third groove formed by three surfaces relative to a fifth supporting member.

FIG. 10 shows another embodiment that is different from the embodiment of FIG. 3, the embodiment of FIG. 7, the embodiment of FIG. 8, and the embodiment of FIG. 9. The embodiment shown in FIG. 10 will now be described, focusing on the differences from the embodiment shown in FIG. 3, the embodiment shown in FIG. 7, the embodiment shown in FIG. 8, and the embodiment shown in FIG. 9.

FIG. 10 shows a display module 10, a fourth supporting member 804, and a fifth supporting member 805. The terminal portion of the protection layer 101 of the display module 10 in the second direction D2 may be affixed to the fifth supporting member 805. The terminal portion of the protection layer 101 in the second direction D2 may be affixed to the fifth supporting member 805 by the first adhesive member 503 in the first direction D1. The terminal portion of the protection layer 101 in the second direction D2 may directly contact the fifth supporting member 805 in the second direction D2. The fifth supporting member 805 may include a third groove 1001.

When the foldable display device is folded or unfolded, the fourth supporting member 804 may be received into the third groove 1001 of the fifth supporting member 805 and may slide relative to the fifth supporting member 805. The fourth supporting member 804 may move along the third groove 1001 in the second direction D2 relative to the fifth supporting member 805. The fourth supporting member 804 may be in surface contact with the fifth supporting member 805 in the first direction D1 in the third groove 1001.

The third groove 1001 may be formed on a surface disposed near the fourth supporting member 804 from among the surface of the fifth supporting member 805. The third groove 1001 may be formed by three continuous surfaces of the fifth supporting member 805. The third groove 1001 may be shaped as a rotated U. The terminal portion of the fourth supporting member 804 in the second direction D2 protruding in the second direction D2 from the surface of the fourth supporting member 804 may be accommodated in the third groove 1001. The third groove 1001 may face the fourth supporting member 804 in the second direction D2.

The fourth supporting member 804 may be surrounded by the fifth supporting member 805. The fourth supporting member 804 may contact the fifth supporting member 805 in the first direction D1.

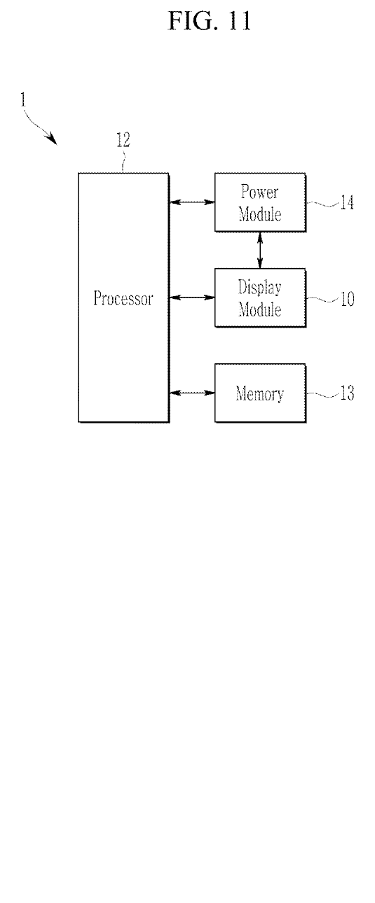

FIG. 11 is a block diagram of the foldable display device according to an embodiment. Referring to FIG. 11, the foldable display device 1 according to an embodiment may include a display module 10, a processor 12, a memory 13, and a power module 14.

The foldable display device may be an example of an electronic device.

The processor 12 may include at least one of a central processing unit (CPU), an application processor (AP), a graphic processing unit (GPU), a communication processor (CP), an image signal processor (ISP), and a controller.

The memory 15 may store data information necessary for operations of the processor 12 or the display module 10. When the processor 12 executes an application stored in the memory 15, video data signals and/or input control signals are transmitted to the display module 10, and the display module 10 can process the received signals to output video information through the display screen.

The power module 14 may include a power supply module such as a power adapter or battery device, and a power conversion module that converts the power supplied by the power supply module to generate the power necessary for the operation of the foldable display device 1.

While the present disclosure has been described with reference to embodiments thereof, it will be apparent to those of ordinary skill in the art that various changes and modifications may be made thereto without departing from the scope and spirit of the present disclosure as set forth in the following claims.

What is claimed is:

1. A foldable display device comprising:
a display module including a display panel having a first surface and a second surface on opposite sides, a protection layer disposed on the first surface, and a plate disposed on the second surface, the display panel, the protection layer, and the plate are stacked in a first direction;
a first supporting member including a third surface facing the plate and a fourth surface opposite the third surface, and further including a protrusion protruding from the fourth surface; and
a second supporting member including a first support facing the first supporting member in the first direction and having a first groove that accommodates the protrusion, and a second support extending in the first direction from the first support and facing a terminal portion of the protection layer,
wherein the terminal portion of the protection layer is affixed to the second supporting member, and
when the foldable display device is folded from an open position, the protrusion moves relative to the first groove in a second direction crossing the first direction.

2. The foldable display device of claim 1, wherein
the first groove is an opening penetrating the first support, and the foldable display device further includes
a first connecting member having a length of the second direction that is greater than a length of the first groove in the second direction and contacting the protrusion penetrating the first groove in the first direction, and
a second connecting member penetrating the first connecting member and coupled to the protrusion.

3. A foldable display device comprising:
a display module including a display panel having a first surface and a second surface on opposite sides, a protection layer disposed on the first surface, and a plate disposed on the second surface, the display panel, the protection layer, and the plate are stacked in a first direction;
a third supporting member including a third support facing the plate in the first direction, and a fourth support extending in the first direction from the third support and facing a terminal portion of the protection layer, the third support including a second groove; and
a sliding member including a junction facing the plate in the first direction and extending in the first direction, and a hook facing the junction in the first direction and having a length in a second direction crossing the first direction that is greater than a length of the junction in the second direction,
wherein the terminal portion of the protection layer is affixed to the fourth support, and
when the foldable display device is folded from an open position, the sliding member moves relative to the second groove in the second direction.

4. The foldable display device of claim 3, wherein
a portion of the third support is arranged between the terminal portion of the hook in the second direction and the plate, and restricts movement of the display module in the first direction.

5. The foldable display device of claim 3, wherein
the terminal portion of the protection layer is affixed to the fourth support in the first direction by a first adhesive member.

6. The foldable display device of claim 3, wherein
the sliding member and the plate are integrally formed.

7. The foldable display device of claim 3, further comprising
a second adhesive member disposed between the junction and the plate.

8. The foldable display device of claim 3, wherein
the terminal portion of the protection layer directly contacts the fourth support in the second direction.

9. The foldable display device of claim 3, wherein
the display module further includes a transparent layer disposed between the protection layer and the display panel, and
the terminal portion of the protection layer protrudes further in the second direction than a terminal portion of the transparent layer.

10. The foldable display device of claim 3, wherein
the second groove includes a first groove portion disposed near the plate and a second groove portion distant from the plate, a length of the first groove portion in the second direction is less than a length of the second groove portion in the second direction,
the junction is accommodated in the first groove portion, a length of the first groove portion in the second direction is greater than a length of the junction in the second direction, and
the hook is accommodated in the second groove portion, and a length of the second groove portion in the second direction is greater than a length of the hook in the second direction.

11. The foldable display device of claim 3, wherein
an entire region of a surface of the protection layer is exposed from the third supporting member.

12. A foldable display device comprising:
a display module including a display panel having a first surface and a second surface on opposite sides, a protection layer disposed on the first surface, and a plate disposed on the second surface, the display panel, the protection layer, and the plate are stacked in a first direction;
a fourth supporting member facing the plate in the first direction and extending in a second direction crossing the first direction; and
a fifth supporting member having a third groove facing the fourth supporting member in the second direction, extending in the first direction, and facing a terminal portion of the protection layer,
wherein the terminal portion of the protection layer is affixed to the fifth supporting member, and
when the foldable display device is folded from an open position, the fourth supporting member moves relative to the third groove in the second direction.

13. The foldable display device of claim 12, wherein
the fourth supporting member is in surface contact with the fifth supporting member in the first direction in the third groove.

14. The foldable display device of claim 12, wherein
the terminal portion of the protection layer is affixed to the fifth supporting member in the first direction by a first adhesive member.

15. The foldable display device of claim 12, wherein
the third groove is formed on a surface of the fifth supporting member that is disposed near the fourth supporting member.

16. The foldable display device of claim 12, further comprising
an adhesive layer disposed between the fourth supporting member and the display module.

17. The foldable display device of claim 12, wherein
the terminal portion of the protection layer directly contacts the fifth supporting member in the second direction.

18. The foldable display device of claim 12, wherein
the display module further includes a transparent layer disposed between the protection layer and the display panel, and
the terminal portion of the protection layer protrudes further in the second direction than a terminal portion of the transparent layer.

19. The foldable display device of claim 12, wherein
a terminal portion of the fourth supporting member in the second direction protrudes further in the second direction than a terminal portion of the plate in the second direction.

20. The foldable display device of claim 12, wherein
an entire region of a surface of the protection layer is exposed from the fifth supporting member.
